(19) United States
(12) Patent Application Publication
(10) Pub. No.: US 2012/0000833 A1
(43) Pub. Date: Jan. 5, 2012

(54) Magnetically Enhanced Recycling of Plastics

(75) Inventors: Marcus David Shelby, Fall Branch, TN (US); Freddie Wayne Williams, Kingsport, TN (US); Rondell Paul Little, JR., Elizabethton, TN (US)

(73) Assignee: EASTMAN CHEMICAL COMPANY, Kingsport, TN (US)

(21) Appl. No.: 12/828,343

(22) Filed: Jul. 1, 2010

(51) Int. Cl. B03C 1/00; H01F 1/00; B32B 3/10; B03C 1/01

(52) U.S. Cl. 209/3.3; 252/62.54; 428/206

(57) ABSTRACT

The present invention relates to the use of ferromagnetic materials to improve the recyclability of plastic packaging.

### FIELD OF THE INVENTION

The present invention relates to the use of magnetic separation and encoding to enhance the recycling of plastics.

### BACKGROUND OF THE INVENTION

Due to environmental reasons, there is increasing interest in the recycling of plastics. Many recycling activities are thermal processes using thermoplastics as a heat source and recycling for cascade use in which a lowering of the physical properties of recycled thermoplastics is not a problem.

Sorting of plastics appears to have been of low priority in the art thus far. Of the uses found in the art, magnetic separation has been used to remove contaminants from plastics or from food. U.S. Pat. No. 6,864,294 involves a method for recycling plastic materials which involves removing solid matter other than thermoplastic material from thermoplastic material by use of magnetic separation as well as other steps. U.S. Pat. No. 7,631,767 involves mixing magnetic particles into a thermoplastic material so that metal contaminants are more easily removed from food.

Current recycling is also limited in effectiveness due to the difficulty in gathering and sorting various types of plastics. This is further complicated by the increasing diversity of packaging materials, multilayer structures, label types, and colors, that do not easily fit within existing general recycling categories.

### SUMMARY OF THE INVENTION

The present invention involves the use of magnetic separation and encoding to enhance the recycling of plastics.

In one embodiment, the present invention relates to a method of sorting plastic articles comprising:

(a) incorporating ferromagnetic particles into or onto a plastic article;

(b) exposing said plastic articles to a magnetic field; and

(c) separating said plastic articles directly from a mixed waste stream.

In one embodiment, the present invention relates to a method wherein said ferromagnetic particles are painted onto a label.

In one embodiment, the present invention relates to a method wherein said ferromagnetic particles are coated onto a label.

In one embodiment, the present invention relates to a method wherein said ferromagnetic particles are incorporated into a paint or coating and then painted or coated onto a label.

In one embodiment, the present invention relates to a method wherein said ferromagnetic particles are incorporated into an ink and then printed onto a label.

In one embodiment, the present invention relates to a method wherein said ferromagnetic particles are incorporated into an ink and then printed onto a label.

In one embodiment, the present invention relates to a method wherein said ferromagnetic particles are incorporated into an ink and then printed directly onto said plastic article.

In one embodiment, the present invention relates to a method wherein said ferromagnetic particles are incorporated into an adhesive material used to bond a label to said plastic article.

In one embodiment, the present invention relates to a method wherein said ferromagnetic particles are incorporated into or onto a cap or other closure of a plastic article.

In one embodiment, the present invention relates to a method wherein said ferromagnetic particles are incorporated into the neck of a plastic bottle.

In one embodiment, the present invention relates to a method of sorting plastic articles comprising:

(a) encoding information concerning a plastic article into ferromagnetic particles;

(b) incorporating said ferromagnetic particles into or onto said plastic article;

(c) exposing said plastic articles to a magnetic field capable of reading said information; and

(d) separating said plastic articles directly from a mixed waste stream.

In one embodiment, the present invention relates to a method of sorting plastic articles comprising:

(a) encoding information concerning a plastic article into ferromagnetic particles;

(b) incorporating said ferromagnetic particles into or onto said plastic article;

(c) exposing said plastic articles to a magnetic reader or scanner; and

(d) separating said plastic articles directly from a mixed waste stream.

In one embodiment, the present invention relates to a method of sorting plastic articles comprising:

(b) incorporating said ferromagnetic particles into or onto said plastic article;

(c) exposing said plastic articles to a magnetic reader or scanner; and

(d) separating said plastic articles directly from a mixed waste stream.

In one embodiment, the present invention relates to a method of sorting plastic articles comprising:

(a) incorporating said ferromagnetic particles into or onto said plastic article;

(b) using a different type of ferromagnetic particle for each type of plastic article to be separated;

(c) exposing said plastic articles to a magnetic field capable of reading each ferromagnetic particle type; and

(d) separating said plastic articles directly from a mixed waste stream.

In one embodiment, the methods of the present invention apply to bottles.

In one embodiment, the methods of the present invention apply to containers.

In one embodiment, the invention comprises any plastic article comprising ferromagnetic particles.

In one embodiment, the invention comprises a plastic article comprising a label containing ferromagnetic particles.

In one embodiment, the methods of the invention comprise ferromagnetic particles being incorporated into an ink and then printed onto a label which is then attached to the plastic article.

In one embodiment, the methods of the invention comprise ferromagnetic particles being incorporated into an ink and then printed onto a label which is then attached to an article of manufacture, for example, an aluminum can.

In one embodiment, the invention comprises an article of manufacture comprising a label wherein ferromagnetic particles are incorporated into an ink and then printed onto a label.

### DETAILED DESCRIPTION OF THE INVENTION

The present invention relates to a method of sorting articles of manufacture comprising:

(a) incorporating ferromagnetic particles into or onto an article of manufacture;

(b) exposing said articles to a magnetic field; and

(c) separating said articles directly from a mixed waste stream.

The present invention relates to a method of sorting plastic articles comprising:

(a) incorporating ferromagnetic particles into or onto a plastic article;

(b) exposing said plastic articles to a magnetic field; and

(c) separating said plastic articles directly from a mixed waste stream.

While plastics are not magnetically active, they can be made so in some embodiments via the incorporation of ferromagnetic fillers and/or inks. By printing magnetically active particles onto the labels, it has been discovered that the package can then be magnetically separated from a mixed waste stream. Furthermore, information about the type of plastic, the color and the layer structure, can be encoded into the label and read by a magnetic reader so that more refined sorting of the waste streams can take place.

One embodiment of the present invention is to paint a section of the label of the container with a ferromagnetic containing ink (e.g. containing iron particles). This will then allow the container to be magnetically lifted and separated out of a mixed waste stream—something that has traditionally been limited to only steel containers and cans. As a result, the need for manual sorting of the plastics can be eliminated because a large magnet (or electromagnet) at the sorting facility can attract and lift out these recyclable containers directly from the mixed waste stream. Furthermore, the magnetic material can be separated away from the reclaimed container as part of the normal recycle process so that it does not also contaminate the reclaimed plastic.

As a further component of the invention, the magnetic paint can be used to encode compositional information about the container in a manner similar to a magnetic stripe, For example, the ferromagnetic paint can contain information on the type of resin(s) used in the container, the color, and the structure (i.e. if it is multilayer). By incorporating this information into the label, a magnetic reader or sensor can then determine the most appropriate sorting bin to place the container. With this automation, both the extraction and sorting processes are greatly improved thereby greatly increasing the quality and quantity of recycled materials.

The magnetically active material of the present invention can consist of any traditional material that is magnetic or can be attracted via a magnet. This class of materials is commonly referred to as “ferromagnetic” and includes iron, nickel, cobalt, “mu-metal”, ferrite (i.e. ceramic with iron oxide), gadolinium, gallium manganese arsenide, magnetite (iron oxide), neodymium alloys, dysprosium, “permalloy”, samarium-cobalt, and yttrium-iron-garnet, Heusler alloys, and others that are well known in the art. Also included are various alloys of these materials including many steels. Note that iron and rare-earth based materials and alloys are the most common. Hereafter, when referring to “iron” particles or “magnetic” or “magnetically active” materials, it is assumed to include all ferromagnetic materials known in the art.

The ferromagnetic materials can be incorporated into the package in a number of ways including, but not limited to the following:

1. Painting or printing of the magnetically active material onto the label. Typical labels are prevented on the back or “second” surface to minimize scuffing. This printing is often followed by an overcoat or “flood coat” to improve the visibility of the printed label. The most preferred place for the ferromagnetic ink is on top of (or as a part of) this overcoat so that it will not affect the aesthetic quality of the label. Labels can be of any type including roll-applied (non-shrink) labels, roll-applied shrink labels, shrink sleeve labels, in-mold labels, paper labels, microvoided labels, multilayer labels, foam labels and other label types well known in the art.

2. Adding the ferromagnetic particles directly into the label stock as a filler. For oriented label film, the iron particles will act as a voiding agent thereby reducing the density and offsetting some of the heavier weight of the label. This filler can be as part of a single layer, multiple layer, as a core or cap layer or as part of a foamed or voided structure. Encapsulating the iron layer in a core layer minimizes the chance of scuffing.

3. Addition of the iron particles into the adhesive used to bond the label to the container. This could be a hot melt adhesive, UV curable adhesive, solvent based system, pressure sensitive adhesive (PSA) or any other traditional bonding method. Once solidified, the seam itself will then act as a magnetically active stripe. This approach has the additional benefit of further removing the contaminant adhesive—which can cause haze issues—from the reclaimed product.

4. Incorporation of iron particles into or onto the cap or closure as a filler or as a paint/coating.

5. Incorporation of iron particles directly into (or onto) the base package. This can be direct printing of the ferromagnetic onto the surface of the package, or incorporation directly into the package material as filler. It can also be added as, for example, a “neck ring” in the case of a bottle, or glued/adhered on to any general type of package. In the case of molded bottles, the paramagnetic filler could be incorporated as a core layer via coextrusion or coinjection to minimize contact with any foodstuffs inside the container.

The ferromagnetic particles of the present invention can be any type of magnetically active material. Particle size is not limited, but particles less than 500 um in size are better from the standpoint of good dispersion. More preferred are particles sizes between about 0.1 um and 100 um. These particles can be applied directly or pre-dispersed in an ink, paint, or as a general filler. They can also be “non-magnetized” or already in a permanent magnetic state. The most preferred application method is to print the ink on the label using rotogravure, flexographic, lithographic, or screen printing methods. It can also be applied using a spray method, a doctor blade or any other such method used to apply a coating. Thickness of the coating is not limited, but will typically be determined by the concentration of iron particles in the ink/paint and the strength of the magnet used to pick up the container (a stronger magnet needs fewer iron particles and therefore will work with a thinner coating).

Another embodiment of the present invention is the application of the ferromagnetic material to the label substrate via sputtering or vapor deposition methods. Most metalized packaging films use aluminum which is non-magnetic. Nevertheless, the same process can be used to apply a ferromagnetic coating instead.

Another embodiment of the present invention is the direct incorporation of solid pieces of paramagnetic material to the package. These could be, for example, solid pieces of sintered ferrite, or a small piece of paramagnetic material that is glued or otherwise attached to the package.

In the case of magnetically active labels, the label stock can be of any material including polyester, paper, polystyrene, cellophane, PVC, nylon, styrenics, polylactic acid (PLA), polyolefin, polycarbonate and so forth. The label can be single or multilayer, foamed voided, laminated, metalized, etc using any traditional method well known in the art. The magnetically active material can be dispersed throughout, or in only a single layer (e.g. a core or cap layer).

The package itself can be any type of container such as a box, pouch, can, cup, bottle, tray, etc. It can also be made from any material including paper, plastic or even non-magnetic metal (e.g. aluminum cans. Preferred container materials include those containing polyester, polyolefin, PVC, PLA, nylon, polycarbonate, polystyrene, and paper.

The typical recycle process in operation today relies on the containers being manually sorted by the consumers prior to arriving at the reclaim facility. This is because there is no cost effective way for sorting the material directly from a mixed waste stream. Various optical sorting methods have been proposed for sorting the materials although none have proven to be commercially viable.

Once this material arrives, it is then ground up whole, typically with the label still attached. Using PET bottle recycle as an example, this results in a mix of both desirable PET plastic flake and undesirable label flake. Next, air is blown through the flake in one is known as the air elutriation step (in Europe a water based elutriation step is often used instead). This results in significant separation as the thinner and lighter label flake is more easily carried out by the air stream. While this elutriation removes much of the flake, but its efficiency is governed by the density and thickness of the labels. Thicker and heavier labels tend to stay with the PET flake whereas the lighter low density label is quickly removed. In the case of label stock based on PVC, this can pose problems as PVC contaminant in PET can lead to serious degradation problem during subsequent re-use of the PET flake.

Following this step, the remaining PET flake is then washed in a hot caustic water solution for cleaning. As part of this additional label flake is further removed via a sink-float mechanism. Label flake that has a density less than the caustic solution (about 1.03 to 1.05 g/cc) will float to the top where it can be easily skimmed off. More dense label material will tend to sink and stay with the PET flake (which has a density of 1.33 to 1.35 g/cc), thereby serving as a contaminant. Because the label is often of a different material than the underlying container, and also contains inks/pigments, it can cause undesirable haze and color problems with the reclaimed polyester flake and should therefore be minimized.

For the present invention, a number of modifications are made to the above described recycle process. One or more of the following processing steps can be envisioned:

1. The use of large electromagnets or permanent magnets (e.g. traditional or rare earth magnets) to lift out the magnetically modified containers directly from a mixed waste stream, without the need for the consumer to pre-sort the materials. The waste stream can take on many forms but typically might involve the waste traveling under the electromagnet on a conveyor of some type. Desirable and recyclable containers would be pulled out of the stream, and could then be dumped into a separate holding bin by simply de-energizing the electromagnet.

2. The use of portable electromagnets for collecting general litter and trash on public grounds, roadsides and so forth. Currently, most waste on the side of roadways consists of paper, plastic and aluminum, none of which can be picked up magnetically. This makes current trash pickup a manual process. By making some or all of these packages “magnetically active”, it would then be possible for quick trash clean-up by, for example, sweeping the roadside with an electromagnet mounted to a truck (or carried).

3. The use of additional magnets or mechanical means to aid in the alignment of the recycled packages to aid in sorting and readout of any encoded information.

4. The incorporation of magnetic readers or scanners to aid in sorting of the containers. After the container or package has been lifted, a magnetic reader could then read off information about the bottle (i.e. resin, type, color, label material, number of layers) and then use this information to properly sort the containers. The reader can be any standard type using, for example, a pick-up coil, Hall-effect sensors, and so forth.

5. The addition of sorting magnets in the elutriation and/or sink/float process to further capture and separate the magnetic label flake. In the sink-float step, the magnets would likely be submersed to pull the magnetically active flake away from the reclaim material.

6. A process for reclaiming and reusing the magnetic flake. This can include pyrolysis of the flake, or other chemical means to separate and recover the iron or other ferromagnetic particles.

The capture of the desirable containers can occur by methods well known in the art. For example, the magnetic separator can be mounted above a conveyor to pick up containers as they flow by. The separator can be manually cleaned or self-cleaning. For the latter case, an example is to have a separate belt that flows cross-wise to the main flow stream and resides just between the magnet and waste material so that it gets pushed off of the magnet. Similarly, the separating magnets can be mounted in the stream, such as with a grating, or can be a part of the conveyor system, such as with a magnetic wheel under the belt that pulls the reclaim. If the magnetic wheel is at the end of the conveyer, it can catch and hold the desirable reclaim while the rest of the waste is discharged off the end of the chute. The desirable reclaim is then pulled around the wheel to be discharged at a different point underneath the conveyer.

The magnets (or electromagnets) of the present invention should ideally have a field strength of at least 500 gauss at a distance of 2.5 mm (0.1 inch) from the magnetic pole. Higher magnetic strengths of at least 1000 gauss are even more desirable in order to allow attraction at a greater distance.

The ferromagnetic material of the present invention can be applied to the whole label although for cost and compatibility issues, it is preferred that it only be applied to a small region. The iron particles could be applied as a solid patch, or in a pattern that could effectively encode information. Many possible patterns can be envisioned. For example, the pattern might be stripes of different widths that could be read in a manner similar to a UPC code. Reading could then be done both magnetically and optically depending on the equipment at hand, and the magnetic activity would still allow the container to be picked up from a mixed waste cycle stream. Alternately the standard recycle code (i.e. “1” to “7”) could be incorporated by having from one to seven magnetic strips. While simple, it would be straightforward for a magnetic sensor to read during sorting and would be less sensitive to the containers orientation during readout.

In another embodiment, the iron particles could be painted in the form of an RFID antenna. Since they are conductive they would still be able to receive incident triggering energy, while still maintaining the magnetic lifting/sorting capability. The RFID signal could serve multiple purposes including sorting of the recycle, but also, for example, to aid in-store inventory management.

In another embodiment, the ferromagnetic material is directly encoded with information in much the same way that a magnetic stripe on a credit card, or tape in a cassette is recorded. Ferrromagnetic materials can be made into permanent magnets by applying a magnetic field that is above the coercive strength of the material. Using this approach, the ferromagnetic material could be encoded with analog or digital type information, or something as simple as a series of dots/dashes. There is no limitation to what is encoded, other than that the sorting system will need to orient and “read” this information in a consistent manner as the container passes by.

Yet another embodiment of the present invention is to use the ferromagnetic material to align the containers/packages during sorting and handling. Depending on how the material is encoded, alignment may be critical for proper readout. For example, if a bottle is encoded with information that can only be read in an axial direction, then it is important that it be aligned such that it passes by the reader/sensor in a near-axial orientation. This can be accomplished in a number of ways including the following:

1. A stripe of ferromagnetic material can be poled such that one end is magnetized in the north direction (N) and the other end is polarized in the south direction (S). This can be accomplished by applying a strong magnetic field (i.e. above the coercive strength of the ferromagnetic material) and of the opposite polarity to induce permanent magnetization. For example, one end of the stripe might be magnetized in the N direction by apply a very strong S-aligned external field, while the other is given a S polarity by using a strong N-aligned external field. Just as a compass needle will spin and align itself in the Earth's magnetic field, the package will likewise have similar alignment from a properly aligned externally applied magnet or electromagnet.

2. Placement of ferromagnetic material at two or more different locations on the container. With the use of multiple magnets that are properly spaced, the container will tend to align in such a way that the ferromagnetic regions on the container are at minimal distance from the multiple magnets. For example if, a bottle is painted with iron particles on both the top and bottom of the container (i.e. axially spaced but on the same side of the bottle), then two magnets that are mounted above the waste flow stream but spaced in the flow direction, will tend to spin/orient the bottle axially with the ferromagnetic patches pointing upward for easier reading.

3. A stripe of magnetic material can be applied in the preferred alignment direction and a long bar magnet (or series of magnets) can then be used to align the container. If the bar magnet is aligned, for example, above the recycle stream, it will twist and rotate so that the paramagnetic stripe is directly under and aligned with the bar magnet.

This is not meant to be an exhaustive or limiting list as many different types of container orientation can be envisioned depending on the type and mounting of the magnetic reader. For example, it is also possible to incorporate the magnetic reader and alignment step into the same step such that the package is lifted, aligned and read all in one step.

By applying such magnetically active materials to traditionally non-magnetic materials, this should greatly increase the quantity of recycle material that is recovered while also reducing the cost to do so. With more reclaim material available, it also helps to have enough reclaim material available to make processes like chemical recycling/depolymerization more cost effective.

Plastics contemplated within the scope of the invention are any known in the art. Embodiments of plastics useful in the present invention include but are not limited to polyesters, for example, terephthalate based polyesters, including but not limited to polyethylene terephthalate; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(estercarbonates); polycarbonates such as LEXAN® (a polycarbonate from General Electric); polysulfones; polysulfone ethers; and poly(ether-ketones) of aromatic dihydroxy compounds; polyvinylchloride polymers (PVC); polylactic acid polymers (PLA); nylons; polyolefins; or mixtures of any of the foregoing polymers.

Any article of manufacture known in the art is contemplated within the scope of this invention. In one embodiment, the article of manufacture can be a can or container or a bottle. In another embodiment, the article of manufacture can be an aluminum can or an aluminum container or an aluminum bottle.

Any plastic article known in the art is contemplated within the scope of this invention. For the purposes of this invention, containers and bottles can include any known in the art.

Examples of bottles include but are not limited to bottles such as baby bottles; water bottles; sports bottles, juice bottles; large commercial water bottles having a weight from 200 to 800 grams; beverage bottles which include but are not limited to two liter bottles, 20 ounce bottles, 16.9 ounce bottles; medical bottles; personal care bottles, carbonated soft drink bottles; hot fill bottles; water bottles; alcoholic beverage bottles such as beer bottles and wine bottles; and bottles comprising at least one handle.

These bottles can include but are not limited to injection blow molded bottles, injection stretch blow molded bottles, extrusion blow molded bottles, and extrusion stretch blow molded bottles.

Methods of making bottles include but are not limited to extrusion blow molding, extrusion stretch blow molding, injection blow molding, and injection stretch blow molding. In each case, the invention further relates to the preforms (or parisons) used to make each of said bottles.

These bottles include, but are not limited to, injection blow molded bottles, injection stretch blow molded bottles, extrusion blow molded bottles, and extrusion stretch blow molded bottles. Methods of making bottles include but are not limited to extrusion blow molding, extrusion stretch blow molding, thermoforming, injection blow molding, and injection stretch blow molding.

Other examples of containers include, but are not limited to, containers for cosmetics and personal care applications including bottles, jars, vials and tubes; sterilization containers; buffet steam pans; food pans or trays; frozen food trays; microwaveable food trays; hot fill containers, amorphous lids or sheets to seal or cover food trays; food storage containers; for example, boxes; tumblers, pitchers, cups, bowls, including but not limited to those used in restaurant smallware; beverage containers; retort food containers; centrifuge bowls; vacuum cleaner canisters, and collection and treatment canisters.

The following examples are intended to be purely exemplary of the invention and are not intended to limit the scope thereof.

### EXAMPLES

### Comparative Example 1

### Traditional Non-Magnetic Packaging

A 20 oz polyester commercial soda polyester bottle and a 12 oz aluminum soft drink can were collected and tested for magnetic activity. A ferrite/ceramic rectangular magnet (45 mm by 20 mm and 10 mm thick) was applied to the containers to try and “lift” or move them. The ceramic magnet has a field strength such that it is capable of lifting approximately 2 kg of iron as measured. Neither container had any response to the magnet since the aluminum is diamagnetic, and the polyester is only weakly paramagnetic.

### Example 1

### Application of Ferromagnetic Material to a Traditional Roll-Applied Label

The same 20 oz soft drink bottle used in CE1 was used for this example as well. The roll-applied polypropylene label was removed from the container and the back surface painted with a magnetic spray paint (Krylon™ Magnetic Paint). The paint contains iron particles dispersed in a propellant and binder material. Three light coats were applied and the label allowed to dry before placing back on the bottle (cyanoacrylate adhesive was used to re-adhere the seam). The bottle was then retested with the same magnet as used in CE1.It was found that the bottle could be lifted off of the table with the magnet, yet the magnetic paint was not visible on the bottle, nor did it affect the visual aesthetics. With two magnets side by side (to increase surface area), the bottle could be held in any orientation, even vertically.

### Example 2

### Application of Ferromagnetic Material in a Stripe

A similar container to that in Example 1 was used except this time the magnetic paint was applied in 3 axially oriented stripes. The outermost stripes were approximately 1 cm wide, and the center stripe was approximately with a 3 mm spacing between them. Total area of the label covered was only about 25%. The bottle exhibited similar response as Example #1 to the external magnet. Furthermore, a reading device could conceivably detect the different stripes and use this to sort the container appropriately.

### Examples 3 and 4

### Application of Ferromagnetic Material to a Shrink Label

Example 3 consists of a 16 oz polyester container with a clear shrink sleeve made from Eastman Embrace LV™ copolyester having a density of 1.30 g/cc. Before applying and shrinking the sleeve around the container, a 25 mm wide stripe of magnetic paint was applied in a circumferential direction about 3 cm from the bottom of the container, and on the back surface of the label. The sleeve was applied to the container using a heat gun. After application, the sleeve still had a look that was pleasing to the eye and was also magnetically active.

Example 4 was similar to 3 except that microvoided shrink film was used instead. The voided film was produced from Eastman Embrace HY™ copolyester/additive and had a density of 0.93 g/cc . The voided film is naturally opaque and so the metallization layer was not visible once the label was applied to the bottle. This bottle was also magnetically receptive to the ceramic magnet as described above.

### Example 5

### Application of a Ferromagnetic Material to a Bottle Cap

In this example, a bottle similar to CE1 was used except this time the outside of the bottle cap was coated with magnetic paint. As before, the bottle could be manipulated and lifted with the magnet except in this case, via the cap instead of through the label.

### Example 6

### Application to an Aluminum Can

A 12 oz aluminum can similar to CE1 was used. The bottom half of the can was painted with the magnetic spray paint. After drying, it was found that the aluminum can was now responsive to the ceramic magnet and could be lifted/manipulated unlike in CE1.

The invention has been described in detail with reference to the embodiments disclosed herein, but it will be understood that variations and modifications can be effected within the spirit and scope of the invention.

1. A method of sorting plastic articles comprising:
(a) incorporating ferromagnetic particles into or onto a plastic article;
(b) exposing said plastic articles to a magnetic field; and
(c) separating said plastic articles directly from a mixed waste stream.

2. The method of claim 1 wherein said ferromagnetic particles are painted onto a label.

3. The method of claim 1 wherein said ferromagnetic particles are coated onto a label.

4. The method of claim 1 wherein said ferromagnetic particles are incorporated into a paint or coating and then painted or coated onto a label.

5. The method of claim 1 wherein said ferromagnetic particles are incorporated into an ink and then printed onto a label.

6. The method of claim 1 wherein said ferromagnetic particles are incorporated into an ink and then printed onto a label.

7. The method of claim 1 wherein said ferromagnetic particles are incorporated into an ink and then printed directly onto said plastic article.

8. The method of claim 1 wherein said ferromagnetic particles are incorporated into an adhesive material used to bond a label to said plastic article.

9. The method of claim 1 wherein said ferromagnetic particles are incorporated into or onto a cap or other closure of a plastic article.

10. The method of claim 1 wherein said ferromagnetic particles are incorporated into the neck of a plastic bottle.

11. A method of sorting plastic articles comprising:
(a) encoding information concerning a plastic article into ferromagnetic particles;
(b) incorporating said ferromagnetic particles into or onto said plastic article;
(c) exposing said plastic articles to a magnetic field capable of reading said information; and
(d) separating said plastic articles directly from a mixed waste stream.

12. A method of sorting plastic articles comprising:
(a) encoding information concerning a plastic article into ferromagnetic particles;
(b) incorporating said ferromagnetic particles into or onto said plastic article;
(c) exposing said plastic articles to a magnetic reader or scanner; and
(d) separating said plastic articles directly from a mixed waste stream.

13. A method of sorting plastic articles comprising:
(b) incorporating said ferromagnetic particles into or onto said plastic article;
(c) exposing said plastic articles to a magnetic reader or scanner; and
(d) separating said plastic articles directly from a mixed waste stream.

14. A method of sorting plastic articles comprising:
(a) incorporating said ferromagnetic particles into or onto said plastic article;
(b) using a different type of ferromagnetic particle for each type of plastic article to be separated;
(c) exposing said plastic articles to a magnetic field capable of reading each ferromagnetic particle type; and
(d) separating said plastic articles directly from a mixed waste stream.

15. The method of sorting plastic articles of claims 1, 11, 12, 13 and 14 wherein said plastic articles are bottles.

16. The method of sorting plastic articles of claims 1, 11, 12, 13 and 14 wherein said plastic articles are containers.

17. A plastic article comprising ferromagnetic particles.

18. A plastic article comprising a label containing ferromagnetic particles.

19. A plastic article comprising a label wherein ferromagnetic particles are incorporated into an ink and then printed onto a label.

20. A method of sorting articles of manufacture comprising:
(a) incorporating ferromagnetic particles into or onto an article;
(b) exposing said articles to a magnetic field; and
(c) separating said articles directly from a mixed waste stream.

21. An article of manufacture comprising a label wherein ferromagnetic particles are incorporated into an ink and then printed onto a label.

22. The article of manufacture of claim 21 comprising an aluminum can.
